(19) United States
(12) Patent Application Publication
(10) Pub. No.: US 2025/0149215 A1
(43) Pub. Date: May 8, 2025

(54) PARAMAGNETIC HARD STAINLESS STEEL AND METHOD FOR MANUFACTURING SAME

(71) Applicant: The Swatch Group Research and Development Ltd, Marin (CH)

(72) Inventors: Steve CLERC, Neuchatel (CH); Joël PORRET, Marin-Epagnier (CH); Stewes BOURBAN, Chabrey (CH)

(73) Assignee: The Swatch Group Research and Development Ltd, Marin (CH)

(21) Appl. No.: 18/888,241

(22) Filed: Sep. 18, 2024

(30) Foreign Application Priority Data
Nov. 7, 2023 (EP) 23208263.6

(51) Int. Cl. H01F 3/00; C21D 1/18; C21D 6/00; C22C 38/40; H01F 1/00; H01F 41/02

(52) U.S. Cl. CPC H01F 3/00; C21D 1/18; C21D 6/004; C22C 38/40; H01F 1/0018; H01F 41/0206; C21D 2211/001; C21D 2211/005

(57) ABSTRACT

A paramagnetic stainless steel part including a core surrounded by a surface including at least a first zone and at least a second zone, the core and the second zone having a hardness HV1 of between 500 and 900, and a microstructure formed by a sigma phase at a mass percentage of between 40 and 80% and an austenitic phase at a mass percentage of between 20 and 60%, the part wherein the first zone is enriched in Ni relative to the core and the second zone, in that the first zone forms a layer entirely made up of an austenitic phase, the layer being referred to as the austenitic layer, and wherein the austenitic layer has a hardness of less than 400 HV1. Another aspect of the disclosure relates to the method for manufacturing this part.

### TECHNICAL FIELD OF THE INVENTION

The invention relates to a part, in particular a timepiece component, made from a paramagnetic stainless steel with a core hardness of between 500 and 900 HV1 and a surface hardness on a portion of its surface of less than 400 HV1. It further relates to the method for manufacturing this stainless steel part.

### TECHNOLOQICAL BACKAROUND

Hard, non-ferromagnetic metal alloys are used in many fields, essentially for components that are subject to high mechanical and/or tribological stress and must remain insensitive to magnetic fields. This is in particular the case for numerous timepiece components such as wheels, pinions, shafts or springs in the movement. Obtaining high hardnesses is also of interest for external parts, for example for the middle, the bezel, the back, the clasp or the crown. This is because a high hardness, i.e. a hardness in excess of 500 HV, generally procures better scratch and wear resistance and thus a good durability of these components which are exposed to the external environment. Alloys with such levels of hardness are typically ferromagnetic and thus unsuitable for timepiece components.

Recently, a paramagnetic stainless steel with a hardness of between 500 and 900 HV10 has been developed with a composition and microstructure disclosed in the patent document EP 3 835 438. This steel comprises by weight:

$$26 \leq Cr \leq 40 \% , \\ 0 \leq Mn \leq 5 \% , \\ 5 \leq Ni \leq 20 \% , \\ 0 \leq Mo \leq 3 \% , \\ 0 \leq Al \leq 5 \% , \\ 0 \leq Cu \leq 2 \% , \\ 0 \leq Si \leq 5 \% , \\ 0 \leq Ti \leq 1 \% , \\ 0 \leq Nb \leq 1 \% , \\ 0 \leq C \leq 0.1 \% , \\ 0 \leq N \leq 0.1 \% , \\ 0 \leq S \leq 0.5 \% , \\ 0 \leq P \leq 0.1 \% ,$$

the remainder consisting of iron and any impurities, each at a concentration of less than or equal to 0.5%. It has a microstructure formed by a sigma phase at a mass percentage of between 40 and 80% and an austenitic phase at a mass percentage of between 20 and 60%.

It is produced using a special method comprising the following steps of:
Providing or producing a blank with the above-mentioned chemical composition and a predominantly or completely ferritic structure,
Carrying out heat treatment, referred to as hardening treatment, on the blank to obtain the part, the hardening treatment being carried out at a temperature between 65° and 900° C. for a duration of between 30 minutes and 24 hours to transform the ferrite of said structure into an austenitic phase and an intermetallic sigma phase, the hardening treatment being followed by cooling to ambient temperature.

This particular microstructure, which consists of two non-ferromagnetic phases, provides in particular a very good compromise between hardness and toughness, good corrosion resistance and excellent polishability.

However, the microstructure and composition of this steel could be optimised to improve the part's ability to withstand impacts at specific points that are subject to greater stress.

### SUMMARY OF THE INVENTION

The invention consists of optimising the composition and microstructure of the prior art at specific points on the surface of the part that are subject to greater stress.

To this end, the aforementioned steel manufacturing method is modified with a local surface treatment step prior to the hardening heat treatment. This step consists of selectively depositing a gamma-phase producing element, namely nickel, at these specific points and of carrying out a diffusion heat treatment, all before the hardening heat treatment. This diffusion heat treatment allows the nickel to be diffused to a given depth, transforming the ferrite into a 100% austenitic layer, which is ductile, thereby improving impact resistance.

The result is a paramagnetic steel part with a core and a portion of the surface surrounding the core having a high hardness of between 500 and 900 HV1 and with the other portion of the surface having a hardness of less than 400 HV1. The core and said portion of the surface comprise a microstructure formed of the sigma phase and the austenitic phase and the other portion of the surface is formed of austenite without a sigma phase, which makes it possible to reduce the hardness while retaining the paramagnetic nature of the part.

More specifically, this is a paramagnetic stainless steel part including a core surrounded by a surface comprising at least a first zone and at least a second zone,
the core and the second zone having a chemical composition comprising by weight:

$$26 \leq Cr \leq 40 \% , \\ 0 \leq Mn \leq 5 \% , \\ 5 \leq Ni \leq 20 \% , \\ 0 \leq Mo \leq 3 \% , \\ 0 \leq Al \leq 5 \% , \\ 0 \leq Cu \leq 2 \% , \\ 0 \leq Si \leq 5 \% , \\ 0 \leq Ti \leq 1 \% , \\ 0 \leq Nb \leq 1 \% , \\ 0 \leq C \leq 0.1 \% , \\ 0 \leq N \leq 0.1 \% , \\ 0 \leq S \leq 0.5 \% , \\ 0 \leq P \leq 0.1 \% ,$$

the remainder consisting of iron and any impurities, each at a concentration of less than or equal to 0.5%,
said core and said second zone having a hardness HV1 of between 500 and 900, and a microstructure formed by a sigma phase at a mass percentage of between 40 and 80% and an austenitic phase at a mass percentage of between 20 and 60%,
the part being characterised in that the first zone is enriched in Ni relative to the core and the second zone, in that the first zone forms a layer entirely made up of an austenitic phase, said layer being referred to as the austenitic layer, and in that the austenitic layer has a hardness of less than 400 HV1.

More specifically, the method for manufacturing a paramagnetic stainless steel part includes the following steps of:
a) Providing or producing a blank substantially having the shape of the part to be manufactured or being different in shape, the blank having the aforementioned chemical composition and having a predominantly ferritic or entirely ferritic structure,
b) Depositing a layer of Ni over the whole surface or only over the first zone of the surface with a step b′) of locally dissolving the layer of Ni over the second zone if the deposit is applied over the whole surface or with a step of locally machining the second zone,
c) Carrying out heat treatment, referred to as diffusion treatment, on the blank at a temperature of between 1050° C. and 1400° C. to diffuse the Ni over a given depth of the blank beneath the first zone and to transform the ferrite within said given depth into an entirely austenitic phase forming the austenitic layer,
d) Carrying out heat treatment, referred to as hardening treatment, on the blank to obtain the part, the hardening treatment being carried out at a temperature between 65° and 900° C. for a duration of between 30 minutes and 24 hours to transform the ferrite within the core and the second zone into an austenitic phase and an intermetallic sigma phase, the hardening treatment being followed by cooling to ambient temperature.

### BRIEF DESCRIPTION OF THE FIGURES

FIG. 1 shows a cross-sectional view of a part according to the invention with a ductile austenite layer on the surface, observed by optical microscopy under polarised light.

FIG. 2 shows a cross-sectional view, for the same part and observed by optical microscopy under polarised light, of a portion of the surface without the ductile austenite layer, with this portion of the surface and the core having the same microstructure formed by the sigma phase and the austenitic phase.

FIG. 3 shows a cross-sectional view of a part according to the invention with a ductile austenite layer on the surface stopping the propagation of cracks when stressed, observed by electron microscopy.

FIG. 4 is a diagrammatic cross-sectional view of the part according to the invention.

FIG. 5 shows a diagrammatic view of a crown cap with the areas subjected to stress during an impact indicated by the arrows.

FIG. 6 shows the work to fracture in Nmm for samples of different thicknesses with certain samples comprising a layer of ductile austenite at the surface in accordance with the invention and certain samples without the layer of ductile austenite at the surface in accordance with the prior art.

### DETAILED DESCRIPTION OF THE INVENTION

The invention relates to parts made from a paramagnetic stainless steel having a hardness of mainly between 500 and 900 HV1, and to the method for manufacturing parts made from these steels. The HV1 hardness is understood to mean a Vickers hardness measured in accordance with standard ISO 6507-1:2018. By way of example, the part can be a timepiece component. It can be an external component chosen from the non-exhaustive list that includes a middle, a back, a bezel, a crown, a push-piece, a bracelet link, a bracelet, a tongue buckle, a clasp, for example of the folding clasp type, a dial, a hand and a dial index. It can also be a component of the movement chosen from the non-exhaustive list that includes a toothed wheel, a shaft, a pinion, a spring, a bridge, a plate, a screw and a balance.

The parts 1 have a different chemical composition and microstructure at the core 2 of the part and at a portion 3a of the surface around the core 2 (FIG. 4). This portion 3a of the surface, also referred to as the first zone, is enriched in Ni compared to the core 2 of the part and the rest 3b of the surface, also referred to as the second zone, to form an austenite layer 4 after heat treatment. According to the invention, only certain areas of the surface are targeted. These are the areas subjected to the greatest stress during an impact. By way of example, FIG. 5 shows, with the aid of arrows, the inner zones of a crown cap that are subject to stress and require a more ductile layer to improve impact resistance. The surface is not covered by the ductile layer in its entirety, as it would be detrimental to have a ductile layer on the outside of the cap, as a higher hardness is desired for the outside of the part. Another example is that of middles. Certain parts of the middle are used to close the back and are characteristically thin. Increasing the ductility of these parts with a layer of austenite would be highly beneficial.

The nickel-enriched austenite layer is typically less than 500 μm thick and more typically of the order of 10-20 μm thick. It should be noted that the choice of layer thickness will depend on the size of the part, as the ductile layer must occupy a relatively small volume compared with the total volume in order to retain the benefit of an overall hard part.

At the core and on the portion of the surface not enriched with nickel, the part is made of a stainless steel having the following composition by weight:

$$26 \leq Cr \leq 40 \% , \\ 0 \leq Mn \leq 5 \% , \\ 5 \leq Ni \leq 20 \% , \\ 0 \leq Mo \leq 3 \% , \\ 0 \leq Al \leq 5 \% , \\ 0 \leq Cu \leq 2 \% , \\ 0 \leq Si \leq 5 \% , \\ 0 \leq Ti \leq 1 \% , \\ 0 \leq Nb \leq 1 \% , \\ 0 \leq C \leq 0.1 \% , \\ 0 \leq N \leq 0.1 \% , \\ 0 \leq S \leq 0.5 \% , \\ 0 \leq P \leq 0.1 \% ,$$

the remainder consisting of iron and any impurities, each at a concentration of less than or equal to 0.5%.

Preferably, the stainless steel has the following composition by weight:

$$28 \leq Cr \leq 38 \% , \\ 0 \leq Mn \leq 3 \% , \\ 5 \leq Ni \leq 15 \% , \\ 0 \leq Mo \leq 3 \% , \\ 0 \leq Al \leq 3 \% , \\ 0 \leq Cu \leq 2 \% , \\ 0 \leq Si \leq 5 \% , \\ 0 \leq Ti \leq 1 \% , \\ 0 \leq Nb \leq 1 \% , \\ 0 \leq C \leq 0.05 \% , \\ 0 \leq N \leq 0.05 \% , \\ 0 \leq S \leq 0.5 \% , \\ 0 \leq P \leq 0.1 \% ,$$

the remainder still consisting of iron and any impurities, each at a concentration of less than or equal to 0.5%.

More preferably, the stainless steel has the following composition by weight:

$$30 \leq Cr \leq 36 \% , \\ 0 \leq Mn \leq 3 \% , \\ 5 \leq Ni \leq 10 \% , \\ 0 \leq Mo \leq 1 \% , \\ 0 \leq Al \leq 1 \% , \\ 0 \leq Cu \leq 1 \% , \\ 0 \leq Si \leq 3 \% , \\ 0 \leq Ti \leq 1 \% , \\ 0 \leq Nb \leq 1 \% , \\ 0 \leq C \leq 0.05 \% , \\ 0 \leq N \leq 0.05 \% , \\ 0 \leq S \leq 0.5 \% , \\ 0 \leq P \leq 0.1 \% ,$$

the remainder still consisting of iron and any impurities, each at a concentration of less than or equal to 0.5%.

This core with the portion of the surface not enriched in nickel has a hardness HV1 of between 500 and 900, and a microstructure formed by a sigma phase at a mass percentage of between 40 and 80% and an austenitic phase at a mass percentage of between 20 and 60%.

The other portion of the surface has a composition close to that of the core but with nickel enrichment. It has a hardness of less than 400 HV1, preferably of between 150 and 350 HV1. It is entirely constituted by an austenitic phase.

According to the invention, the method for manufacturing a stainless steel part includes a step a) of providing or producing a blank having a composition that falls within the aforementioned ranges. This blank has a predominantly ferritic or, preferably, a 100% ferritic structure. The blank is obtained from a base material subjected to a heat or thermomechanical treatment at a temperature in the range of between 950° C. and 1450° C. followed by quenching. The base material can be in a powder form or in the form of a consolidated material. It can be produced by casting, pressing, metal injection moulding (MIM), additive manufacturing, and more broadly by powder metallurgy. The base material and the heat treatment can conceivably be carried out in a single step, for example, by a selective laser melting (SLM) technique. These different techniques allow a blank to be produced with a base material having dimensions that are substantially equal to those of the part to be produced, in which case a subsequent shaping step is not required.

The composition of the base material is optimised so as to obtain a predominantly or completely ferritic structure when being held at a temperature of between 950° C. and 1450° C. for a duration of between 1 minute and 24 hours. The temperature is chosen so as to obtain a mass fraction of austenite of less than or equal to 40% and a mass fraction of ferrite of greater than or equal to 60%. The presence of austenite makes it possible to obtain minimum hardness and maximum ductility to allow easy shaping, for example by forging, cutting or machining.

The heat or thermomechanical treatment in the range of 950° C.-1450° C. can be used to carry out homogenisation, recrystallisation or stress relieving treatments on base materials obtained by casting or to carry out sintering on base materials in powder form. The treatment in the ferritic or ferritic-austenitic range can be carried out in a single cycle or can involve a plurality of heat or thermomechanical treatment cycles. It can also be preceded or followed by other heat or thermomechanical treatments.

After being held in the ferritic or ferritic-austenitic range, the blank is subjected to rapid cooling, also known as quenching, to a temperature of less than 500° C. in order to prevent the formation of new phases during cooling. Thus, the ferritic or ferritic-austenitic structure is preserved at ambient temperature. Thanks to the compositions according to the invention, the ferritic structure is sufficiently stable to be kept at ambient temperature after rapid cooling but sufficiently metastable to be easily and rapidly transformed into a sigma phase and an austenitic phase on subsequent heat treatment at intermediate temperatures of between 650° C. and 900° C.

At the end of step a), the alloy has a low hardness and high ductility, which can allow easy shaping, for example by forging, blanking or machining.

After step a), the method includes an optional step of shaping the blank by machining, blanking or any operation involving deformation such as forging. This step can be carried out in several sequences. This step is not required if the blank at the end of step a) already has the final shape of the part to be manufactured. This step could also be carried out after the diffusion heat treatment step below. As mentioned below, this step could also be used to selectively, mechanically remove the Ni-enriched layer.

In addition to shaping, a plastic deformation operation can be implemented in particular to increase the ferrite transformation rate in the subsequent step of transforming the ferrite into austenite and into sigma phase. Moreover, as the hardening by strain hardening is low for ferritic structures and the alloy according to the invention is predominantly or completely ferritic before the hardening treatment, this plastic deformation step does not cause any hardening that could be problematic for an optional shaping operation by machining or blanking. This plastic deformation in one or more sequences can be carried out at a temperature below 650° C.

The method then includes steps b) and c), which are more specifically the subject of the invention and are aimed at selectively depositing nickel on the surface of the blank and diffusing this nickel over a given depth of the part. It should be noted again that these steps could optionally be carried out before the shaping step if there is a shaping step.

In step b), the nickel is deposited either on the entire surface of the blank or on a portion of the surface of the blank. Typically, the layer is deposited by galvanisation or PVD. The deposited layer has a thickness of between 1 and 20 μm, preferably between 3 and 10 μm, more preferably between 4 and 10 μm. When the nickel is deposited on only a portion of the surface of the blank, the surface is partially masked so as to target the nickel deposit. Masking can, for example, be carried out with a lacquer which is subsequently dissolved. If the nickel deposit is deposited over the entire surface, a step b′) is carried out to dissolve the deposit where it is not desired or a machining step is carried out to selectively remove the nickel layer before or after the diffusion step, or even after the hardening heat treatment step. One way of locally dissolving the nickel layer can be to mask the areas where the layer is desired, for example using a lacquer or simply by positioning an element such as a plug in the case of a hollow area to be covered with a layer of austenite, and then soaking the part in an acid bath such as diluted HNO₃ for a few hours. The part is then rinsed. At the end of the step of locally depositing the nickel layer, a step c) is carried out to heat treat the part at between 1050° C. and 1400° C., preferably between 1200° C. and 1300° C., for a time of between 5 minutes and 5 hours, preferably between 5 minutes and 1 hour, in order to diffuse the nickel into the alloy and transform this zone previously formed mainly of ferrite into austenite. This results in a part with a layer of ductile austenite at certain areas of the surface. The layer is 100% austenitic, with a thickness that depends mainly on two factors linked to the diffusion of nickel in the alloy, namely the thickness of the Ni deposit and the high-temperature diffusion treatment time.

At this stage of the process, the core and the portion of the surface not enriched with nickel are still predominantly or entirely formed of ferrite. In step d), the blank undergoes a hardening heat treatment at between 650° C. and 900° C., preferably between 700° C. and 800° C., to obtain the final properties. The duration of the heat treatment between 650° C. and 900° C. is set so as to guarantee complete transformation of the ferrite and thus obtain a microstructure formed by a sigma phase and an austenitic phase at the core of the part and on the portion of the surface that is not treated, the nickel-enriched layer formed of austenite remaining stable, with no transformation.

The rate of transformation of the ferrite into austenite+a sigma phase depends in particular on the composition of the alloy and the thermomechanical history thereof, as mentioned hereinabove. Typically speaking, the treatment lasts between 30 minutes and 24 hours. After hardening treatment, the steel has a mass fraction of sigma phase of between 40% and 80% and a mass fraction of austenite of between 20% and 60%, the percentages depending on the chemical composition and the heat treatments carried out. The core and surface of the part not enriched with Ni thus obtained have a high hardness of between 500 and 900 HV1 thanks to the hardening heat treatment.

As with all stainless steels, possible non-metallic inclusions can also be present in small quantities, without affecting the mechanical and magnetic properties. Moreover, machinability-enhancing inclusions, such as manganese sulphides, can also be present in small quantities in the alloy.

This hardening heat treatment step can be followed by an optional surface finishing step e) such as polishing.

Alternatively, in the presence of a blank with an austenite+ferrite structure in step a), the manufacturing method can include an additional step, prior to the Ni diffusion heat treatment of step b), in the temperature range 950° C.-1450° C. to transform the austenite+ferrite structure into a 100% ferritic structure. Alternatively, this step can form a single step with the diffusion step.

To summarise, after the high-temperature heat treatment (950° C.-1450° C.) followed by quenching, the steels have in particular the following properties:
A hardness of between 150 and 400 HV1.
Good ductility with a plastic deformation without cracking of greater than 50% in compression at ambient temperature.
A ferromagnetic behaviour, due to the presence of ferrite.

After localised nickel deposition with diffusion and the hardening heat treatment, the steels according to the invention have in particular the following properties:
A hardness of between 500 and 900 HV1 in the core and on the portion of the surface not enriched with nickel.
A hardness of below 400 HV1 in certain zones of the surface.
A non-ferromagnetic behaviour.
Excellent polishability, thanks to the very fine microstructure.
Good wear resistance.
Improved impact resistance in high-stress zones.
Good corrosion resistance.

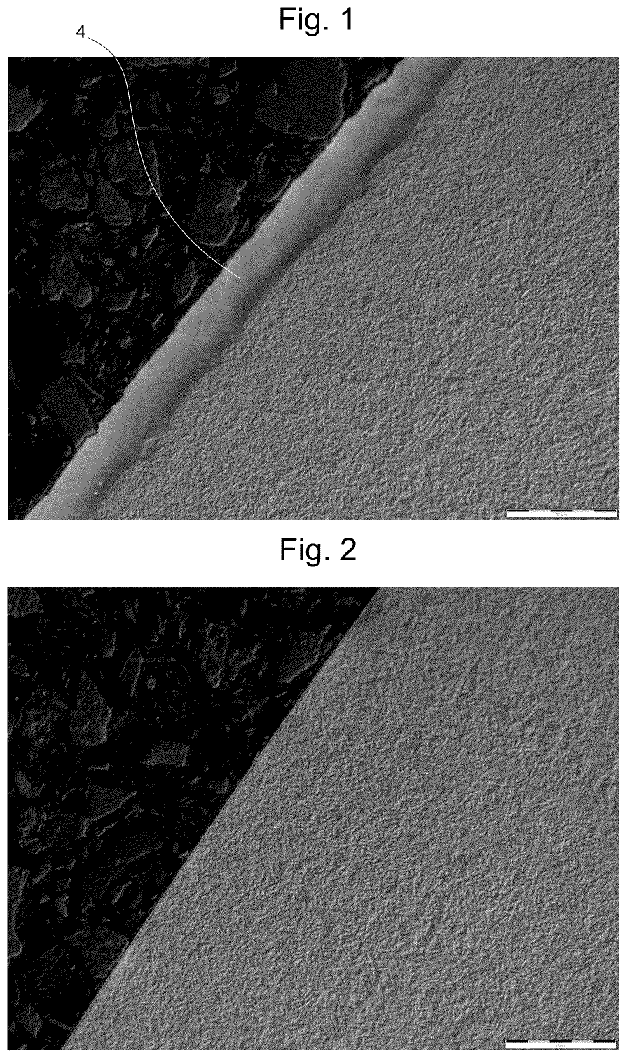

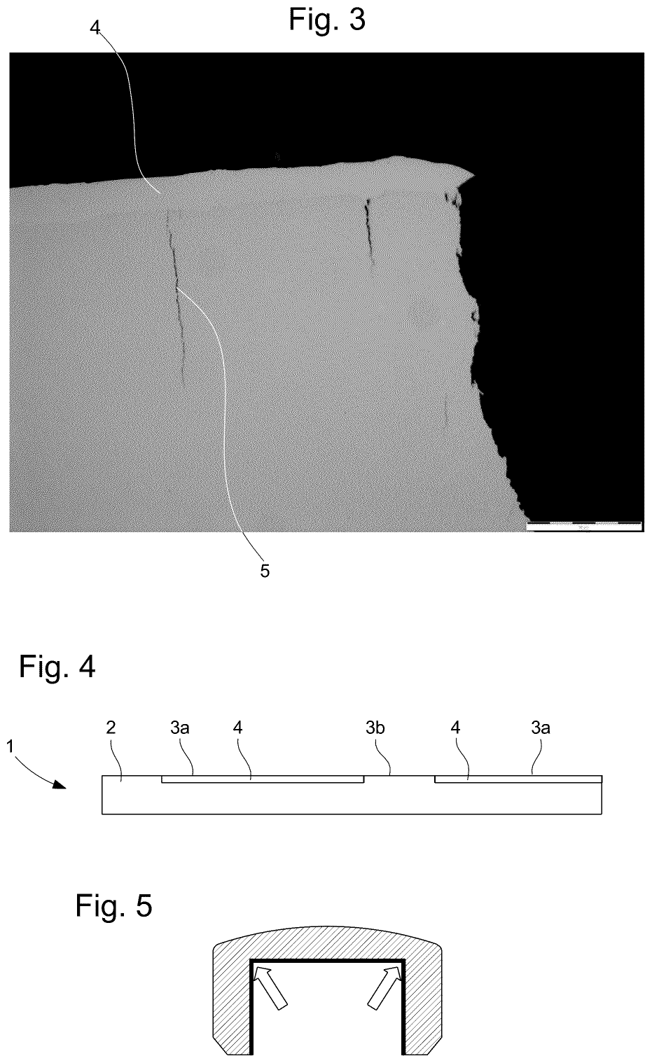

Tests were carried out using a 5 μm thick galvanic nickel deposit made over the entire surface of the parts. The nickel layer was selectively dissolved after masking the areas where the layer was desired. Dissolution was carried out by soaking in a dilute HNO₃ bath, with 20 ml of HNO₃ in 100 ml of H₂O for 19 hours. The nickel-diffusing heat treatment was carried out at 1250° C. for several tens of minutes. The hardening heat treatment was then carried out at 750° C. for 12 hours. As shown in FIG. 1, the austenite layer 4 is 10-20 μm thick. FIG. 2 shows the zones on the surface that do not have an austenite layer. The austenite layer 4 helps to stop the cracks 5 that develop towards the surface of the sample when stressed, thereby delaying fracture (FIG. 3).

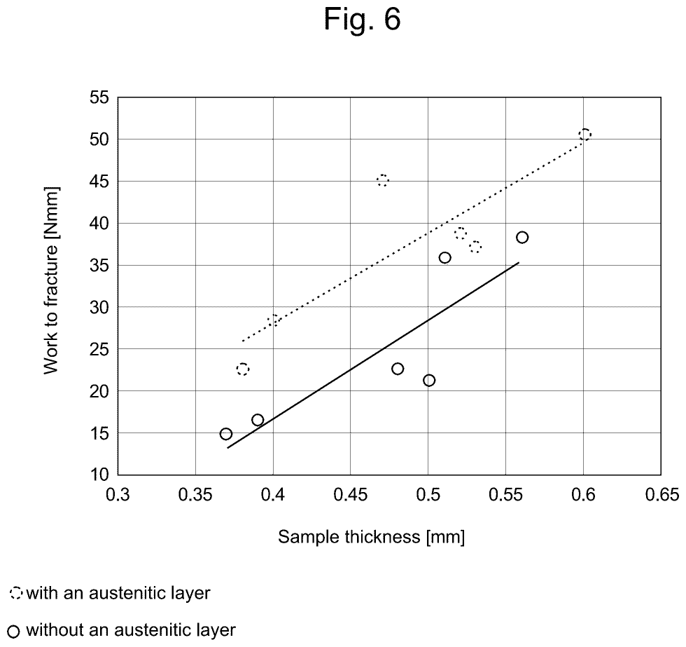

Bending tests were also carried out on specimens with an austenite layer over the entire surface thereof, as opposed to specimens without an austenite layer. The specimens were fully coated with a layer of austenite to simplify the tests. FIG. 6 shows that the presence of an austenite layer results in greater energy absorption during a bending test.

1. A paramagnetic stainless steel part comprising a core surrounded by a surface comprising at least a first zone and at least a second zone,
the core and the second zone having a chemical composition comprising by weight:
$$26 \leq Cr \leq 40 \% , \\ 0 \leq Mn \leq 5 \% , \\ 5 \leq Ni \leq 20 \% , \\ 0 \leq Mo \leq 3 \% , \\ 0 \leq Al \leq 5 \% , \\ 0 \leq Cu \leq 2 \% , \\ 0 \leq Si \leq 5 \% , \\ 0 \leq Ti \leq 1 \% , \\ 0 \leq Nb \leq 1 \% , \\ 0 \leq C \leq 0.1 \% , \\ 0 \leq N \leq 0.1 \% , \\ 0 \leq S \leq 0.5 \% , \\ 0 \leq P \leq 0.1 \% ,$$
the remainder consisting of iron and any impurities, each at a concentration of less than or equal to 0.5%,
said core and said second zone having a hardness HV1 of between 500 and 900, and a microstructure formed by a sigma phase at a mass percentage of between 40 and 80% and an austenitic phase at a mass percentage of between 20 and 60%,
the part comprising the first zone is enriched in Ni relative to the core and the second zone, in that the first zone forms a layer entirely made up of an austenitic phase, said layer being referred to as the austenitic layer, and wherein the austenitic layer has a hardness of less than 400 HV1.

2. The part according to claim 1, wherein the austenitic layer has a hardness of between 150 and 350 HV1.

3. The part according to claim 1, wherein said part is an external component or a component of the horological movement.

4. A method for manufacturing the part made of a paramagnetic stainless steel according to claim 1, comprising the following steps of:
a) providing or producing a blank substantially having the shape of the part to be manufactured or being different in shape, the blank having the chemical composition according to claim 1 and having a predominantly ferritic or entirely ferritic structure,
b) depositing a layer of Ni over the whole surface or only over the first zone of the surface with a step b′) of locally dissolving the layer of Ni over the second zone if the deposit is applied over the whole surface or with a step of locally machining the second zone,
c) carrying out heat treatment, referred to as diffusion treatment, on the blank at a temperature of between 1050° C. and 1400° C. to diffuse the Ni over a given depth of the blank beneath the first zone and to transform the ferrite within said given depth into an entirely austenitic phase forming the austenitic layer,
d) carrying out heat treatment, referred to as hardening treatment, on the blank to obtain the part, the hardening treatment being carried out at a temperature between 65° and 900° C. for a duration of between 30 minutes and 24 hours to transform the ferrite within the core and the second zone into an austenitic phase and an intermetallic sigma phase, the hardening treatment being followed by cooling to ambient temperature.

5. The method according to claim 4, wherein the layer of Ni has a thickness of between 1 and 20 μm.

6. The method according to claim 4, wherein when the Ni is deposited on only the first zone of the surface, said surface is partially masked so as to target the Ni deposit.

7. The method according to claim 4, wherein the local dissolution step b′) is carried out after having masked the first zone.

8. The method according to claim 4, wherein the local dissolution step b′) is carried out in an acid bath such as a HNO3 bath.

9. The method according to claim 4, comprising a step of shaping the blank if said blank in step a) has a different shape to the part to be manufactured, the shaping step being carried out between steps a) and b) or between steps b) and c).

10. The method according to claim 4, wherein the structure of the blank in step a) contains a mass fraction of austenite of less than or equal to 40% and a mass fraction of ferrite of greater than or equal to 60%.

11. A manufacturing method according to claim 4, wherein the structure of the blank in step a) contains 100% ferrite.
